(19) United States
(12) Patent Application Publication
(10) Pub. No.: US 2012/0048883 A1
(43) Pub. Date: Mar. 1, 2012

(54) Assembly for Removing a Medium from a Pressurized Container

(75) Inventors: Hans Heckenberger, Assmannshardt (DE); Hans-Dieter Wiek, Hochdorf (DE); Johann Stempfle, Pfaffenhofen (DE); Herbert Lott, Bad Wurzach-Arnach (DE)

(73) Assignee: Kaltenbach & Voigt GmbH, Biberach (DE)

(21) Appl. No.: 13/257,813

(22) PCT Filed: Mar. 19, 2010
(86) PCT No.: PCT/EP2010/053602

§ 371 Date: Nov. 15, 2011

(30) Foreign Application Priority Data
Mar. 20, 2009 (DE) 10 2009 014 065.4
Feb. 17, 2010 (DE) 10 2010 002 028.1

(51) Int. Cl. B67D 7/08

(52) U.S. Cl. 222/1; 222/52; 222/58; 222/544

(57) ABSTRACT

An assembly for removing a medium from a pressurized container, the assembly having a cut-off valve that is located on an outlet line for the container and a sensor for detecting the pressure prevailing in the container. The assembly is also provided with a control unit that controls the cut-off valve on the basis of the pressure determined by the sensor in order to remove the desired quantity of medium.

The present invention relates to an assembly for removing a medium from a pressurized container. This may in particular be a component of a device which is provided for disinfecting, sterilizing and/or maintaining medical instruments. Dental instruments in particular are intended to be prepared using the device.

Medical or dental hand-held devices or handpieces are tubular components which the doctor grasps as a gripping sleeve during treatment. A hand-held device conventionally used in dentistry is a so-called hand-held drill which carries at the front end thereof a treatment tool, in particular a drill, and is connected at the rear end thereof to a supply hose by means of a coupling. Supply lines for energy extend through the hand-held device in order to drive the treatment instrument and fluid pipes for treatment media, for example air and/or water. A distinction is often made between so-called turbine hand-held devices, in which compressed air is provided in order to supply a turbine arranged in the front end region, and so-called motorized hand-held devices which have an electric motor as a drive unit.

In order to maintain the function of the hand-held devices, maintenance is required from time to time, in particular for the rotatably supported drive elements. Furthermore, the increasingly stringent hygiene requirements in dentistry require that preparation of hand-held devices be carried out at regular intervals of time. In this instance, the successful preparation and compliance with the corresponding provisions must be fully documented by the dentist, which involves considerable complexity in terms of operators and organization.

Manual preparation of hand-held dental devices was previously carried out by the instruments first being sprayed with disinfectant and externally washed after use on the patient. In contrast, internal cleaning of the instruments was not generally carried out. In the meantime, however, there are on the market cleaning and disinfection devices in which the instruments are prepared before they are subjected to an oil care operation. The mechanical preparation affords clear advantages over manual maintenance of the instruments since only a mechanical method enables safe and reproducible cleaning and maintenance.

However, the devices known currently can generally be used only for individual preparation steps so that a cleaning operation, a maintenance operation and a sterilization operation have to be carried out separately. All the devices required for this take up a relatively large amount of space, electrical, pneumatic and fluid connections being required for each of the devices. Carrying out complete mechanical preparation of dental instruments using individual devices is accordingly very complex and linked with high costs.

Another disadvantage is that the individual devices are generally not networked with each other, for which reason it is not possible to exchange data between the devices. This again leads to additional effort for the operating staff since it is not possible to produce any continuously automatic documentation of the instrument preparation. Furthermore, in intermediate steps, the instruments must be manually conveyed from device to device which is linked with an intensive deployment of personnel and is very time-consuming.

The storage containers for the various media for preparing instruments may in particular be closed pressurized canisters (propellant gas canisters or so-called two-chamber canisters), that is to say, pressurized containers via which the medium is discharged. If the pressure inside the container is reduced, this also has an effect on the volume flow of the medium discharged. Since reliable and reproducible preparation of the instruments is only possible in principle when a consistent quantity of medium is removed from the containers, however, an object of the present invention is in particular to provide a possibility of keeping the quantity of medium removed constant.

According to the present invention there is proposed to this end an assembly for removing a medium from a pressurized container, which has a blocking valve which is arranged in an outlet pipe for the container, a sensor for detecting a pressure in the container and a control unit, the control unit for removing a desired quantity of medium controlling the blocking valve on the basis of the pressure established by the sensor.

According to the present invention, there is further proposed a method for removing a medium from a pressurized container, the container having an outlet pipe having a blocking valve and, according to the invention, the pressure in the container being established and the blocking valve being controlled on the basis of the pressure established.

The solution described not only permits reliable removal of the medium from the container in the desired quantity but can also be used to establish that the canister or container has been emptied. This also contributes to an increase in the operational reliability of the device. The blocking valve may be controlled in particular on the basis of a previously established characteristic line or control line which is stored in a memory of the control unit or a memory connected to the control unit.

Alternatively, the quantity of medium removed could also be established by detecting the weight of the container filled with the medium and determining the weight loss resulting from the medium being discharged. On this basis, the quantity of medium removed can then be established.

According to this alternative solution, there is accordingly proposed an assembly for removing a medium from a pressurized container, having means for detecting the weight of the container filled with the medium and a control unit that determines the weight loss produced by the medium being discharged and on this basis establishes the quantity of medium removed. Accordingly, a method for removing a medium from a pressurized container is also proposed, wherein the weight loss of the container with the medium therein produced by the medium being discharged is determined and the quantity of medium removed is established on this basis.

Finally, another alternative solution involves the assembly further having a storage chamber having a predetermined volume whose inlet is connected to the container, there further being provided a valve via which the outlet of the storage chamber may be optionally connected to the inlet and the container or a consumer and the storage container further having a movable valve element, by which a region connected to the inlet is separated from a region connected to the outlet. According to this variant, a method for removing a medium from a pressurized container is also proposed, wherein a storage chamber connected to the container is initially filled with a predetermined volume and the medium in the storage chamber is subsequently supplied to the consumer.

In all three variants, it is ensured that the quantity of medium removed from the storage containers can be metered in an exact and precise manner.

The invention is intended to be explained in greater detail below with reference to the appended drawings, in which:

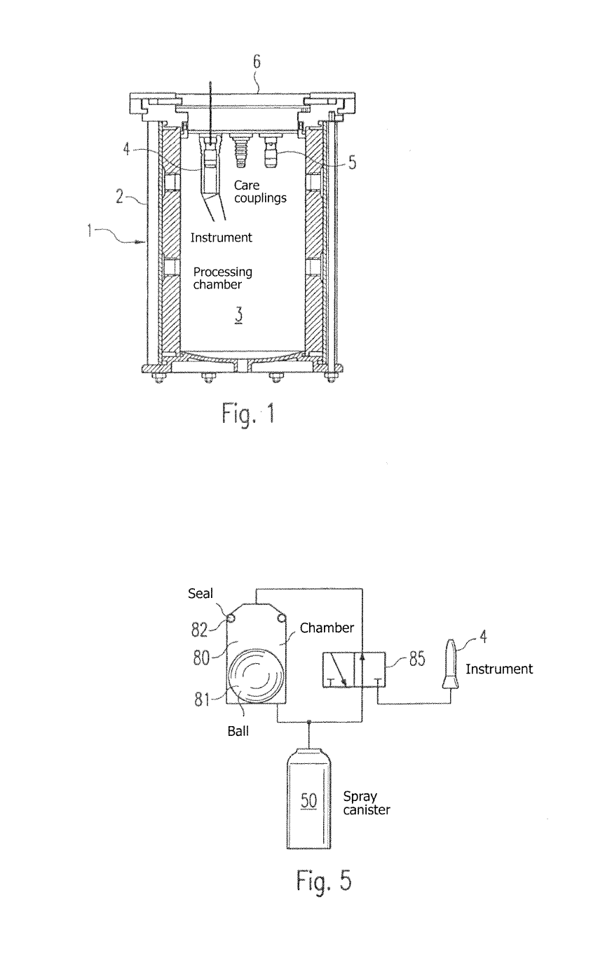

FIG. 1 is a sectional illustration of a processing or rinsing chamber of a device in accordance with the invention for disinfecting, sterilizing and/or maintaining dental instruments;

FIG. 2 schematically illustrates the procedure for metering the quantity of a medium removed from a pressurized storage container;

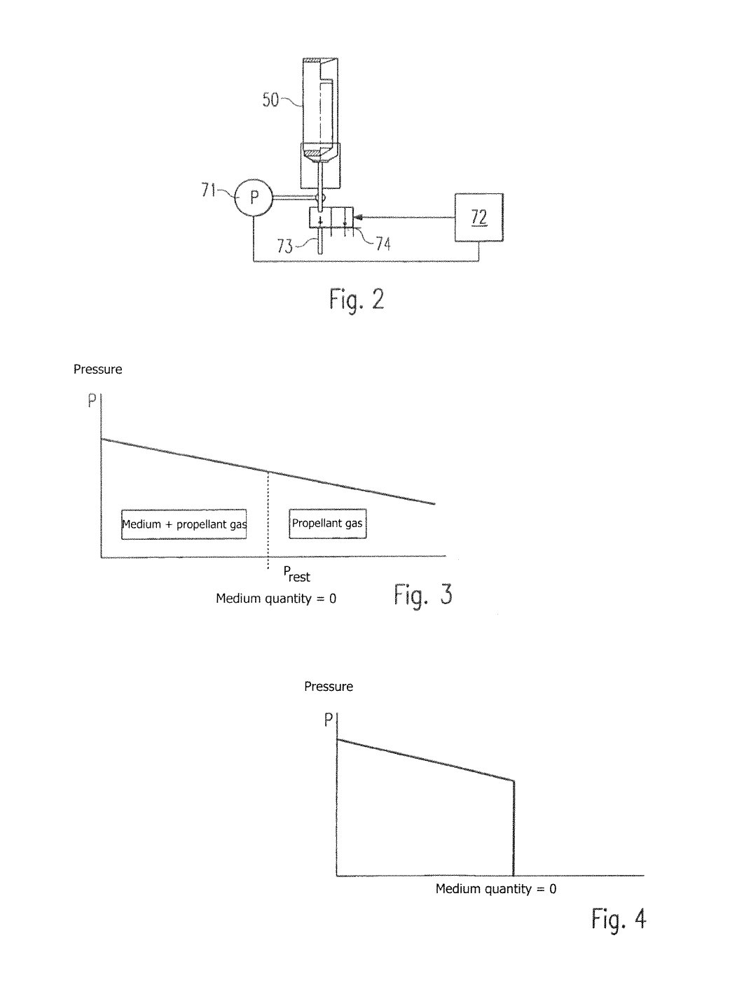

FIGS. 3 and 4 are illustrations of the procedure during the metering of the removal of media in accordance with the invention; and

FIG. 5 illustrates another variant for metering the quantity of a medium removed from a storage container.

FIG. 1 first schematically shows the construction of a device for disinfecting, sterilizing and/or maintaining medical instruments, particularly dental instruments, the device generally being designated 1 below. The central element of the maintenance device 1 in accordance with the invention is a pressurized container 2 which surrounds a processing or rinsing chamber 3. The instruments 4 to be cleaned or maintained are arranged in this rinsing chamber 3 while the process is carried out. The arrangement of the instruments 4 is carried out in this instance by means of an instrument carrier, on which a plurality of insertion locations or couplings 5 are arranged. Various couplings 5 are preferably provided so that instruments 4 with coupling systems from various manufacturers can be prepared. In the present case, the lid or cover 6 of the processing chamber 3 acts as the instrument carrier. This lid 6 ensures the fluid connection of the instruments 4 to be cleaned with respect to a supply system. It is clamped to the collar (rim, flange) of the pressurized container 2 by a locking device and sealed relative thereto. By means of connection tubes which are integrated into the lid 6, the individual instruments 4 and their channels can then be acted on individually or collectively by a cleaning agent and/or maintenance agent.

First, the operating sequence for the cleaning and/or maintenance of the instruments 4 is generally intended to be described below. In this instance, the pressure tightness of the processing chamber 3 is checked before the start of the preparation. It is ensured that the lid 6 is introduced correctly and is locked to the pressurized container 2. Correct connection of the fluid pipes between the lid 6 and pipes extending in the collar of the pressurized container 2 is also checked.

In order to supply the device 1 with water, tap water is preferably filtered by means of an osmosis arrangement with or without a downstream mixed-bed ion exchanger, the dissolved salts being removed. The water at a quality of <15 μS/cm is directed into a storage container at the device side, the filling level being monitored by means of a level switch which is in the form of a float-type switch and the quality being monitored by means of a conductance sensor. The inlet into the storage container is constructed with a so-called cascade for hygiene reasons.

When the instruments are prepared by means of the device according to the invention, the following steps are then carried out successively:

### a) Cleaning

First, water is directed from the above-described storage container into the processing chamber 3, it being possible for this to be carried out by means of a pump or by suction by means of pressure reduction. The water is heated to approximately 45° C. in the processing chamber 3 by means of heating elements. It is ensured that the temperature is not greater than 45° C. in order to prevent coagulation of protein. The water is further circulated by means of a pump and directed onto the outer faces of the instruments 4 in order to clean them by means of spray nozzles which are fitted to the outer surface of the pressurized container 2 or in a central dome. The cleaning water can be directed through the instruments 4 and/or the spray channels of the instruments 4 and/or through the spray nozzles of the processing chamber 3 for external cleaning.

The washing medium can be heated during the circulation so that the faces to be cleaned are first cleaned with cold washing medium. In this instance, the cleaning medium may be introduced into the processing chamber 3 in the form of powder or in tablet form or may be metered from a corresponding storage container. The various possibilities for metering the cleaning medium are described below. The washing medium may comprise surfactants or phosphates and may have a pH value of more than 10. The water is drained from the pressurized container 2 in order to terminate the washing operation.

### b) Rinsing—Neutralization

In a subsequent step, the water is then directed out of the storage container into the processing chamber 3 and heated to approximately 45° C. to 60° C. During the circulation of the water, a rinsing or neutralizing agent is metered from another storage container. Alternatively, a second component of a cleaning tablet may also be dissolved owing to the higher temperature in relation to step a). The fluid is again directed through the instruments 4 and the spray channels in a parallel manner or with time displacement or in interval operation, and/or directed via the spray nozzles onto the outer faces of the instruments 4. In particular, phosphoric acid ester having a pH value of from 3 to 5 is used as the rinsing or neutralizing agent.

The fluid can again be drained from the pressurized container into the discharge channels or remains in the container in order to absorb excess maintenance agent which is discharged from the instruments 4 during the subsequent maintenance operation or in order to rinse the oily outer face of the instruments briefly with warm fluid. In this case, the fluid is not drained until after the maintenance operation, it possibly being helpful to apply compressed air to the instruments 4 in order to prevent water spray from being introduced inside the instruments 4.

### c) Maintenance

In a third step, maintenance agent is directed into the instrument interior from a maintenance agent storage container so that the gears and bearings are lubricated. The maintenance agent may be injected in liquid form as oil or be injected from a pressurized canister into a compressed air jet. It is also possible to foam the oil by means of the propellant contained in the pressurized canister and to fill the instrument interior with this oil/air foam. The air bubbles collapse relatively quickly in this case so that the oil forms a uniform thin oil film in the entire instrument interior. Biodegradable fatty-acid-ester-oil/protein-oil admixtures are used as lubricants.

### d) Rinsing

After the above-described maintenance operation, the instruments can be rinsed on the outer face with the rinsing fluid still in the container. Alternatively, fresh water is supplied to the processing chamber 3 from the storage container by means of a pump and is directed towards the outer faces of the instruments via the spray nozzles.

e) Sterilization—Preliminary pressure reduction

Fresh water is supplied to the processing chamber 3 from the storage container in order to sterilize the instruments. A pressure reduction device is connected for venting in the processing chamber 3, the pressure inside the processing chamber 3 being monitored or recorded.

The air is drawn out of the processing chamber 3 by means of the pressure reduction device. The reduced pressure is reduced as far as atmospheric pressure by the water being heated by means of heating elements. The processing chamber 3 is then filled with water vapor, it being possible to repeat this operation several times in accordance with the sterilization program.

The vaporized volume of water can be replenished for each pressure reduction cycle, the total water quantity necessary for producing the vapor also being able to be introduced into the processing chamber 3 immediately at the start of the sterilization cycle as an alternative thereto.

Alternatively to the production of vapor by means of heating elements in the processing chamber 3, water vapor can also be supplied from a vapor pressure vessel located outside the processing chamber 3 in order to equalize the pressure during venting or for sterilization.

### f) Drying and Cooling

After the sterilization is concluded, the instruments 4 are dried by the water vapor in the processing chamber 3 being brought to condensation. This is achieved in that the container wall or elements in the container are cooled, for example in that water removed from the storage container is directed through it. The water may be supplied continuously or discontinuously. At the end of the cooling operation, the water is directed away. Since there is a temperature of less than 50° C. in the chamber 3, the lid 6 can be opened. The preparation cycle for the instruments 4 is thereby concluded.

The above description shows that it is possible to prepare dental instruments fully automatically with the device 1. Interventions by operators are not necessary so that a very convenient system is provided. Naturally, it is also possible to deviate from the sequence described in order to prepare the instruments.

If the storage container connected is a pressurized canister, for example a propellant gas canister or a so-called two-chamber canister, a particular problem arises. If cleaning or maintenance agent is removed from the storage container during use of the device, the pressure in the canister decreases and the volume flow of the medium being discharged becomes smaller. For reliable and reproducible preparation of the instruments, however, it is absolutely necessary that in principle a constant quantity of medium can be removed from the storage container which makes it necessary for adaptation in terms of time to take place if the volume flow fluctuates in order to keep the quantity of medium removed constant. Furthermore, emptying of the storage container is intended to be detected.

In order to solve this problem, there is first proposed an assembly for the removal of media as illustrated in FIG. 2. In this instance, the pressure inside the canister 50 is detected by means of a pressure sensor 71. A blocking valve 74 arranged on an outlet pipe 73 for the canister 50 is then opened for a given time by means of an electronic control unit 72. In this instance, the pressure-dependent opening time can be stored in the software of the control unit 72 as a control characteristic established beforehand by experiment. It is thereby ensured that a constant quantity of medium can be removed irrespective of the canister pressure or filling level.

By the canister pressure being monitored, it is further also possible to recognize that the storage container 50 is empty, as schematically illustrated in FIGS. 3 and 4. The pressure path is illustrated in accordance with the quantity of medium remaining in the canister, FIG. 3 showing the path for a so-called propellant gas canister and FIG. 4 showing the path for a so-called two-chamber canister.

In a propellant gas canister, the propellant in the canister presses directly on the surface of the medium. If the medium has been completely discharged, propellant gas continues to be discharged from the canister so that the pressure sensor 74 cannot directly detect whether there is still some medium in the canister or whether only the pressure of the propellant gas is acting on the sensor 74. Accordingly, the residual pressure n rest which results for the quantity of medium 0 must be established experimentally. This state is then recognized as the canister being empty.

When a two-chamber canister is used, however, the medium is located in a separate inner container, on which the pressure of the propellant gas acts. If the inner container is completely empty, the pressure at the valve also decreases abruptly to zero, as illustrated, because the propellant gas itself can no longer be discharged from the canister. This pressure decrease can be clearly recognized by the sensor 74 and output via the electronic control unit 72.

It is therefore ensured by means of the solution proposed that the desired quantity of medium is removed from the storage container. Should it be desirable to establish only that the canister is empty, a simple pressure switch can also be used in place of a sensor having an associated electronic control unit.

Alternatively to the above-described procedure, it would also be conceivable to establish the quantity of medium removed from a storage container by measuring the weight. In this instance, all the storage containers, or the storage containers individually, with the media therein are secured to a weighing cell. Before the medium is discharged, the total weight is measured. After or while the medium is discharged, the loss of weight is then established, from which the discharged quantity can then be established. To this end, corresponding calibration would initially be necessary, during which the weight loss produced when a specific quantity of medium is removed is established.

This variant is distinguished by its simple construction, the advantage particularly existing that a single measurement system can be used simultaneously for a plurality of media. The medium to be removed can also be metered precisely in this case.

Finally, a third variant for precise metering is illustrated in FIG. 5. In this instance, an assembly for precise metering is arranged between the storage container 50 and the instrument 4. This comprises a chamber 80, whose inlet and outlet is connected to a 2/3-way valve 85. The inlet of the chamber 80 is further also connected to the spray canister 50 and the valve 85 is connected to the instrument 4.

A ball 81 which can be moved in a vertical direction is located inside the chamber 80 which encloses a predetermined storage volume. A sealing ring 82 is further arranged at the upper end or outlet of the chamber 81. The ball 81 with the sealing ring 82 produces another blocking valve, as will be explained below.

The function in this assembly is as follows. In the rest state, the outlet of the chamber 80 is connected to its inlet by means of the valve 85. Pressure equalization can thereby occur and the chamber 80 is filled with the medium of the storage container 50.

In order to remove a specific volume of the medium, the valve 85 is controlled in such a manner that the outlet of the chamber 80 is connected to the instrument 4. In this instance, the medium flows into the instrument 4 and medium further flows from the canister 50 to the lower side or inlet of the chamber 80. In this instance, the ball 81 moves upwards, the medium flowing until the ball 81 presses against the seal 82. Therefore, a quantity of medium is discharged to the instrument and corresponds precisely to the travel of the ball 81 times the cross-sectional area of the storage chamber 80.

If the valve 85 is subsequently switched to the initial position again, the ball 81 moves onto the base again owing to the resultant pressure equalization owing to its gravitational force and the predetermined volume quantity can be metered again.

All three variants described afford the advantage that a specific quantity of medium may be precisely metered or the quantity of medium discharged may be precisely established. The reproducibility during the preparation of medical instruments is thereby increased substantially.

1. An assembly for removing a medium from a pressurized container comprising a blocking valve which is arranged in an outlet pipe for the container, a sensor for detecting a pressure in the container and a control unit that controls the blocking valve on the basis of the pressure established by the sensor to remove a desired quantity of the medium.

2. An assembly according to claim 1, in wherein the control unit has a memory or is connected to a memory, in which a control line for controlling the blocking valve is stored.

3. An assembly for removing a medium from a pressurized container, having means for detecting the weight of the container filled with the medium and a control unit which determines the weight loss produced by the medium being discharged and on this basis establishes the quantity of medium removed.

4. An assembly for removing a medium from a pressurized container comprising
a storage chamber having a predetermined volume with an inlet connected to the container and a valve via which the outlet of the storage chamber may be optionally connected to the inlet and the container or a consumer,
the storage container having a movable valve element, by which a region connected to the inlet is separated from a region connected to the outlet.

5. An assembly according to claim 1, comprising a component of a device for disinfecting, sterilizing and/or caring for medical instruments.

6. A method for removing a medium from a pressurized container which has an outlet pipe having a blocking valve, the pressure in the container being established and the blocking valve being controlled on the basis of the pressure established.

7. A method for removing a medium from a pressurized container, the weight loss of the container with the medium therein produced by the medium being discharged being determined and the quantity of medium removed being established on this basis.

8. A method for removing a medium from a pressurized container, a storage chamber connected to the container initially being filled with a predetermined volume and the medium in the storage chamber subsequently being supplied to a consumer.
